(19) United States
(12) Patent Application Publication
(10) Pub. No.: US 2025/0180201 A1
(43) Pub. Date: Jun. 5, 2025

(54) A METHOD AND AN APPARATUS FOR BOILER ELECTRIFICATION AND AN ELECTRIFIED BOILER

(71) Applicant: Chromalox, Inc., Pittsburgh, PA (US)

(72) Inventors: Danen LYNN, Pittsburgh, PA (US); Paul NEILSON, Pittsburgh, PA (US); Mark WHEELER, Pittsburgh, PA (US); Chris MOLNAR, Pittsburgh, PA (US); Broman SILLITO, Pittsburgh, PA (US); Jacob WELLER, Pittsburgh, PA (US)

(73) Assignee: Chromalox, Inc., Pittsburgh, PA (US)

(21) Appl. No.: 18/833,647

(22) PCT Filed: Jan. 24, 2023
(86) PCT No.: PCT/US2023/061147

§ 371 Date: Jul. 26, 2024

Related U.S. Application Data
(60) Provisional application No. 63/303,566, filed on Jan. 27, 2022.

(51) Int. Cl. F22B 1/28; F22B 37/00; H05B 3/52

(52) U.S. Cl. CPC F22B 1/285; F22B 37/00; H05B 3/52; H05B 2203/021

(57) ABSTRACT

A method and an apparatus for boiler electrification and an electrified boiler are provided. The method comprises converting a plurality of fire tubes of the boiler to electric heating apparatuses. A first end panel of the boiler, which is positioned over a first end plate of the boiler, which is operatively coupled to the plurality of the fire tubes, is replaced with an electrical enclosure configured for suppling 100 volts to 40,000 volts. The electrical enclosure comprises a hardware control device and a power distribution system. Electrical communication is established between the electrical heating apparatuses and the power distribution system.

### PRIORITY CLAIM

The present application claims priority to U.S. provisional patent application Ser. No. 63/303,566, filed Jan. 27, 2022, which is hereby incorporated by reference in its entirety.

### FIELD

The present disclosure relates to a method and an apparatus for boiler electrification and an electrified boiler.

### BACKGROUND

Converting a boiler from hydrocarbon powered to electrical powered can be time consuming and complex. In some previous examples, it may have been more efficient to scrap the hydrocarbon powered boiler and replace it with a brand new electrical powered boiler. There are challenges with converting a boiler from hydrocarbon powered to electrical powered.

### SUMMARY

In a general aspect, various embodiments of the present invention are directed to a method for converting a boiler from hydrocarbon powered to electrical powered. The method comprises converting a plurality of fire tubes of the boiler to electric heating apparatuses. For example, a heat transfer medium and an electrical heating element can be introduced into the plurality of the fire tubes and/or at least a portion of a first fire tube of the plurality of fire tubes can be removed and an electrical immersion heating apparatus can be introduced in place of the at least portion of the first fire tube. A first end panel of the boiler, which is positioned over a first end plate of the boiler, which is operatively coupled to the plurality of the fire tubes, is replaced with an electrical enclosure configured for suppling 100 volts to 40,000 volts. The electrical enclosure comprises a hardware control device and a power distribution system. The hardware control device can comprise a ground fault circuit interrupter, a current monitor circuit, a voltage monitor circuit, a water detection circuit, a fluid level control circuit, a low fluid control circuit, a pressure control circuit, a pump control circuit, a temperature limit control circuit, or a combination thereof. Electrical communication is established between the electrical heating apparatuses and the power distribution system.

In another general aspect, an electrical immersion heating apparatus for a boiler is provided. The apparatus comprises a first mounting flange, a second mounting flange, a heating element, a support structure, and optionally a spacer. The first mounting flange is configured to mount in a first fire plate in the boiler. The second mounting flange is configured to mount in a second fire plate in the boiler. The heating element extends from the first mounting flange towards the second mounting flange. A gap is defined between the heating element and the second mounting flange. The support structure extends from the first mounting flange to the second mounting flange. The support structure can be a rod, a bar, and/or a tube. The spacer extends from the support structure to the heating element.

In another general aspect, an electrical immersion heating system for a boiler with multiple heating elements included in an assembly is provided. The apparatus comprises a first mounting flange, a second mounting flange, electrical immersion heating elements, a support structure, and optionally a spacer. The heating elements extend from the first mounting flange towards the second mounting flange and the heating elements are attached to the first mounting flange by a bolted gasketed flange or a weld. A gap is defined between the heating elements and the second mounting flange. The support structure may be provided between the first and second mounting plates to strengthen the boiler.

In another general aspect, various embodiments of the present invention are directed a boiler comprising an electrical immersion heating apparatus as described herein.

The method and an apparatus for boiler electrification and an electrified boiler according to embodiments of the present invention can provide a more efficient conversion of a boiler from hydrocarbon powered to electrical powered. These and other benefits that can be realized with embodiments of the present invention will be apparent from the description that follows.

### BRIEF DESCRIPTION OF THE DRAWINGS

The features and advantages of various examples of the present invention, and the manners of attaining them, will become more apparent, and the examples will be better understood, by reference to the following description of examples taken in conjunction with the accompanying drawings, wherein:

FIG. 1 illustrates a partial cross-sectional view of a conventional boiler powered by hydrocarbon fuel;

FIG. 2 illustrates a flow diagram of a method for boiler electrification according to the present disclosure;

FIG. 3 illustrates a schematic of an electrified boiler according to the present disclosure;

FIG. 4A is a perspective view of an example of an immersion electrical heating apparatus according to the present disclosure;

FIG. 4B is a side view of the immersion electrical heating apparatus of FIG. 4A;

FIG. 5A is a perspective view of an example of an immersion electrical heating apparatus according to the present disclosure;

FIG. 5B is a side view of the immersion electrical heating apparatus of FIG. 5A;

FIG. 5C is a front view of the immersion electrical heating apparatus of FIG. 5A;

FIG. 6A is a perspective view of an example of an immersion electrical heating apparatus according to the present disclosure;

FIG. 6B is a side view of the immersion electrical heating apparatus of FIG. 6A;

FIG. 7A is a perspective view of an example of an immersion electrical heating apparatus according to the present disclosure;

FIG. 7B is a side view of the immersion electrical heating apparatus of FIG. 7A;

FIG. 7C is a cross-sectional view taken along line 7C-7C of the immersion electrical heating apparatus of FIG. 7B;

FIG. 8A illustrates a perspective view of a portion of a boiler;

FIG. 8B illustrates a perspective view of the portion of the boiler in FIG. 8A with at least a portion of the first fire plate removed;

FIG. 8C illustrates a perspective view of the portion of the boiler in FIG. 8B with a first example of a replacement plate; and

FIG. 8D illustrates a perspective view of the portion of the boiler in FIG. 8B with a second example of a replacement plate.

Corresponding reference characters indicate corresponding parts throughout the several views. The exemplifications set out herein illustrate certain examples, in one form, and such exemplifications are not to be construed as limiting the scope of the examples in any manner.

### DETAILED DESCRIPTION

Certain exemplary aspects of the present disclosure will now be described to provide an overall understanding of the principles of the composition, function, manufacture, and use of the compositions and methods disclosed herein. An example or examples of these aspects are illustrated in the accompanying drawings. Those of ordinary skill in the art will understand that the compositions, articles, and methods specifically described herein and illustrated in the accompanying drawings are non-limiting exemplary aspects and that the scope of the various examples of the present invention is defined solely by the claims. The features illustrated or described in connection with one exemplary aspect may be combined with the features of other aspects. Such modifications and variations are intended to be included within the scope of the present invention.

Converting a boiler from hydrocarbon powered to electrical powered can be time consuming and complex. Replacing the boiler can be difficult as buildings sometimes are built around the boiler and the boiler cannot be removed and/or replaced easily (e.g., must be cut into multiple pieces, building must be modified). The present disclosure provides a method and an apparatus for boiler electrification and an electrified boiler, which can be used to efficiently convert the boiler from hydrocarbon powered to electrical powered and may not require modification of a building around the boiler. The present disclosure can retrofit an existing system while having minimal impact to the existing feedwater and steam outlet infrastructure.

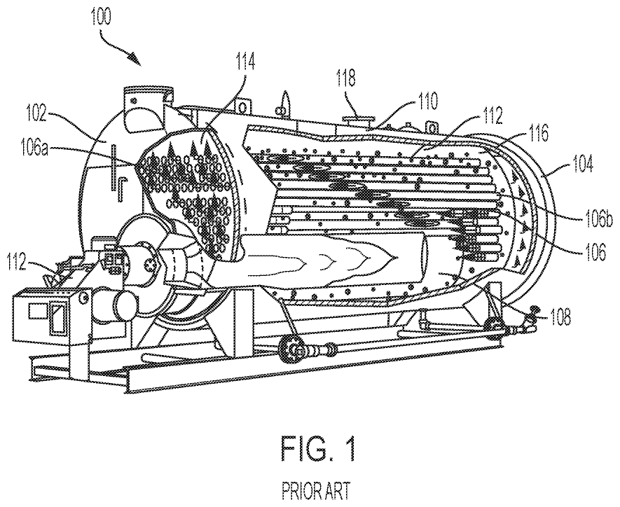

Referring to FIG. 1, a conventional boiler heat exchanger 100 powered by a hydrocarbon fuel source is provided. The boiler 100 comprises a first end panel 102, a second end panel 104, an elongate body 110 extending from the first end panel 102 to the second end panel 104, and a burner 112 operatively coupled to the first end panel 102 and configured to combust a hydrocarbon fuel inside of a combustion chamber 108. The combustion of the hydrocarbon fuel generates heated exhaust gases, which can be used to heat a fluid in the fluid cavity of the boiler 112. The combustion chamber 108 extends from a first end plate 114 of the boiler 100 to a second end plate 116 of the boiler 100 and fire tubes 106 extend from the first end plate 114 to the second end plate 116. The combustion chamber 108 and the fire tubes 106 are operatively coupled to the first end plate 114 and the second end plate 116. For example, first ends 106a of the fire tubes 106 can be welded and/or brazed to the first end plate 114 and second ends 106b of the fire tubes 106 can be welded and/or brazed to the second end plate 116.

The heated exhaust gases pass through the inside of the combustion chamber 108 and then through the inside of fire tubes 106, thereby heating walls of the combustion chamber 108 and walls of the fire tubes 106. The fluid (e.g., water) in the fluid cavity 112 contacts the outside of the walls of the combustion chamber 108 and the walls of the fire tubes 106.

The first end panel 102 and/or the second end panel 104 can be an access panel that can be removable in order to service the boiler 100. The first end panel 102 and/or the second end panel 104 can form a fluid tight seal with the elongate body 110 in order to keep heated exhaust gases from undesirably leaking out of the desired exhaust path through the boiler 100. The elongate body 110 can be substantially cylindrical.

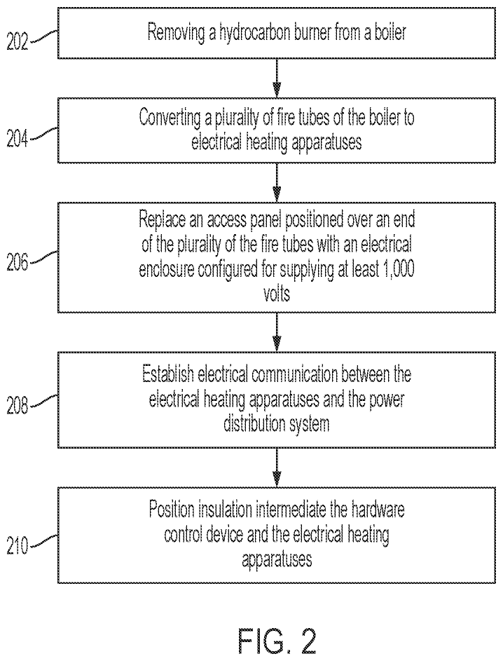

Referring to FIG. 2, a method for converting a boiler from hydrocarbon powered to electrical powered according to various embodiments of the present invention is provided. For convenience, the following methods will be described in terms of boiler 100, but it is understood the methods described herein can be applied to other heat exchanger types. The method can comprise removing the hydrocarbon burner 112 from the boiler 100 at step 202. Removing the hydrocarbon burner 112 can remove the heat source for heating the fluid in the fluid cavity 112. Additionally, the first panel 102 of the boiler 100 can be removed.

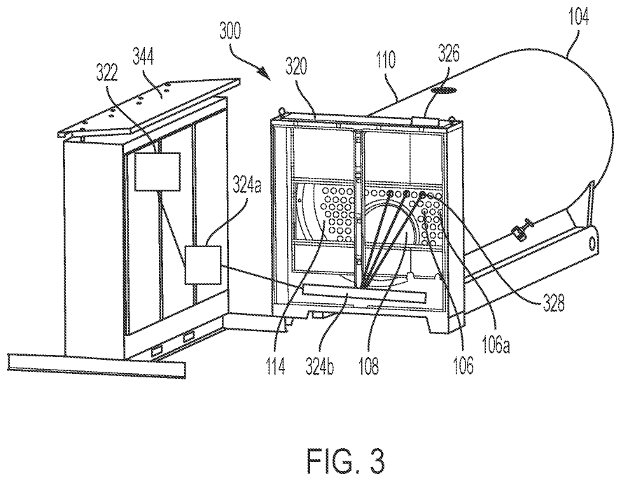

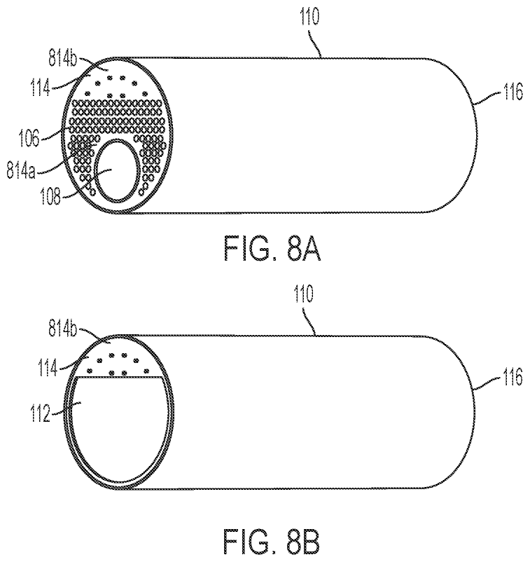

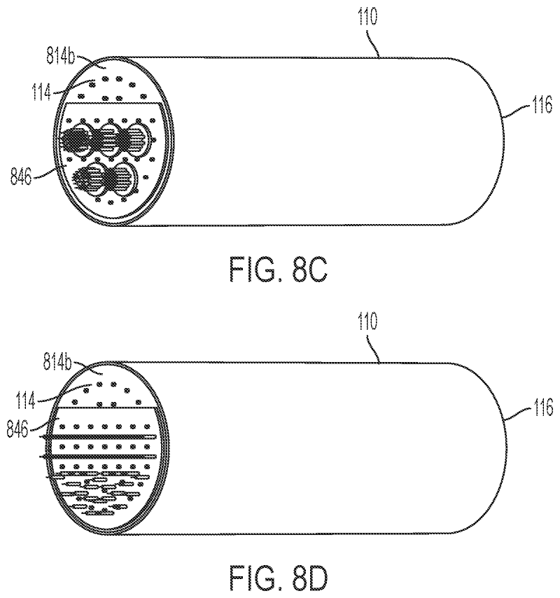

A new heat source can be added to the boiler 100 to replace the hydrocarbon burner 112. For example, at step 204, a plurality of fire tubes 106 of the boiler 100 can be converted to electric heating apparatuses (e.g., electrical heating apparatuses 328 as shown in FIGS. 3, 8C, and 8D, and described herein below). The electrical heating apparatuses can provide heat directly to fluid in the fluid chamber 112 and/or indirectly through the walls of the fire tubes 106. For example, a heat transfer medium (e.g., magnesium oxide, oil, aluminum oxide, or a combination thereof) and an electrical heating element can be introduced into each of the plurality of the fire tubes 106 and the electrical heating elements can indirectly heat the fluid in the fluid chamber 112 through the walls of the fire tubes 106. The ends 106a and 106b of the fire tubes 106 can be sealed to maintain the heat transfer medium within the fire tubes 106. In this manner, the original structure of the fire tubes 106 may remain intact. In various examples, all of the fire tubes 106 can be converted to electric heating apparatuses or less than all of the fire tubes 106 can be converted to electric heating apparatuses.

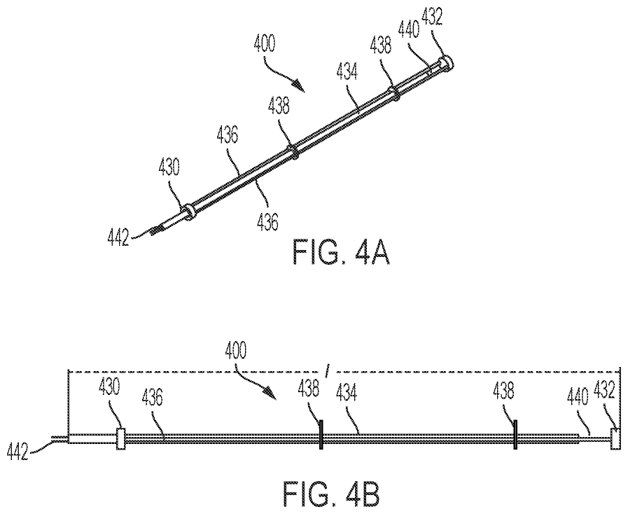

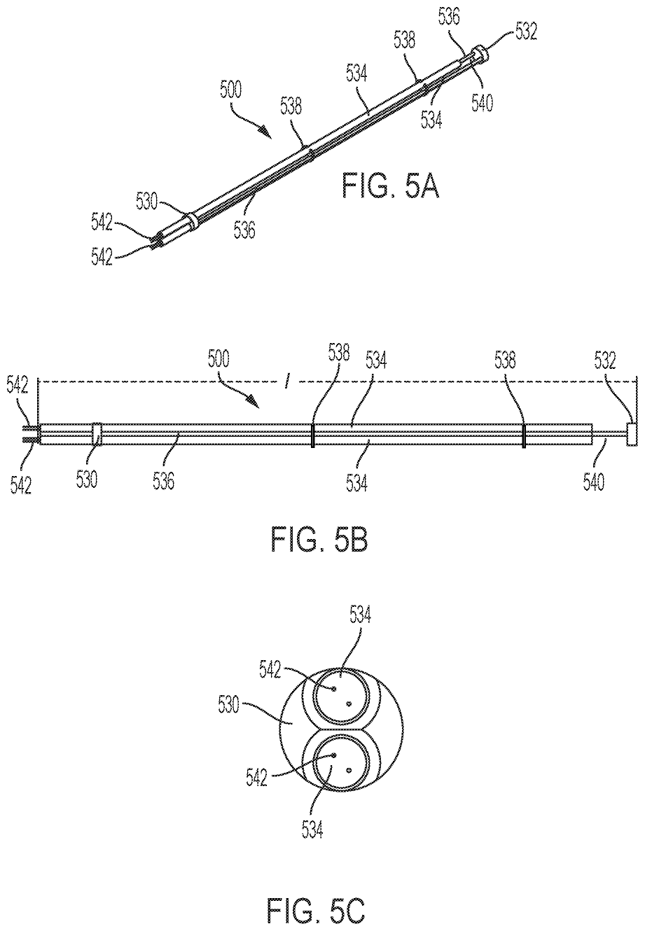

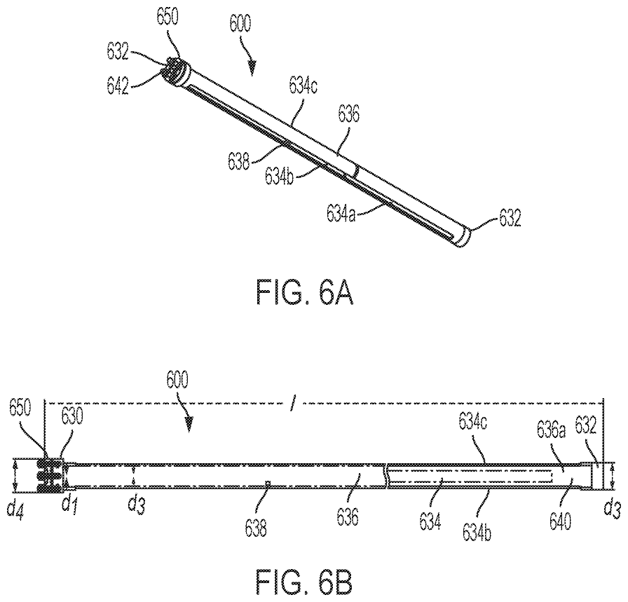

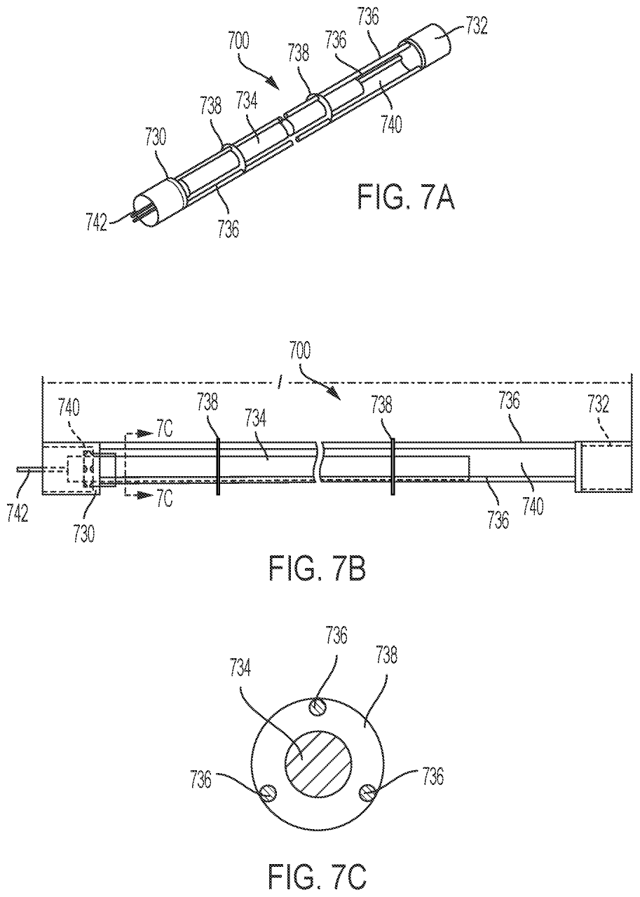

In addition or alternatively, at least a portion of a fire tube or fire tubes of the plurality of fire tubes 106 can be removed and an electrical immersion heating apparatus or electrical immersion heating apparatuses can be introduced in place of the at least portion or portions that was/were removed. In this manner, the electrical immersion heating apparatus can be in contact with and directly heat the fluid in the fluid chamber 112. For example, the electrical immersion heating apparatus can be an immersion electrical heating apparatus 400 as shown in FIG. 4, an immersion electrical heating apparatus 500 as shown in FIG. 5, an immersion electrical heating apparatus 600 as shown in FIG. 6, and/or an immersion electrical heating apparatus 700 as shown in FIG. 7, all as described herein below. In various examples, referring to FIGS. 8A-8B, at least a portion 814a of the first end plate 114 and/or second end plate 116 can be removed with the at least a portion of a first tube or fire tubes. Referring to FIGS. 8C-8D, a replacement plate 846c, 846d can be introduced in plate of the first end plate 114 and/or second end plate 116. FIG. 8C illustrates the replacement plate 846c comprising electrical heating apparatuses 328 on flanges 848 and FIG. 8D illustrates the replacement plate 846d comprising electrical heating apparatus 328 welded to the replacement plate 846d.

Referring again to FIG. 3, the first end panel 102 positioned over the first end plate 106 that is operatively coupled to the plurality of the fire tubes 106 can be replaced with a first electrical control enclosure 320 configured for suppling 100 volts to 40,000 volts, such as, for example, 115 volts to 38,000 volts or at least 1,000 volts (e.g., a medium voltage electrical enclosure) and a second electrical enclosure 344, at step 206 in FIG. 2. For example, a boiler system 300 that was converted to electrical power is shown in FIG. 3. The boiler system 300 was configured with the first electrical enclosure 320 and the second electrical enclosure 344. The second electrical enclosure 344 can comprise a hardware control device 322 and a power distribution system 324a. The first electrical enclosure 320 can comprise a power distribution block 324b (e.g., power distribution block, terminal block) and optionally a vent 326. The first electrical enclosure 320 can be sealed to the elongate body 110 of the boiler 100 such that a fluid tight seal is formed between the elongate body 110 and the first electrical enclosure 320. Replacing the first end panel 102 of the boiler 100 can enable a more efficient process of converting the boiler to electrical powered by allowing access to electrical connections and decreasing the wire runs needed between electrical components, such as, the power distribution block 324b and the electrical heating apparatuses 328.

The hardware control device 322 can be in electrical communication with the power distribution system 324a, such that the hardware control device 322 can control the electrical power provided by the power distribution system 324a to each electrical heating element 328 through the power distribution block 324b. The hardware control device 322 can comprise various circuitry required to control the functions and operations of the boiler 100. For example, the hardware control device 322 can comprise a ground fault circuit interrupter, a current monitor circuit, a voltage monitor circuit, a water detection circuit, a fluid level control circuit (e.g., fluid level in the fluid chamber 112), a low fluid control circuit, a pressure control circuit, a pump control circuit, and/or a temperature limit control circuit.

Providing a water detection circuit in the bottom of the first electrical enclosure 320 can detect if a fire tube 106 and/or an electrical apparatus 328 is leaking. Typically, a water detection circuit is not present on the fire side of the boiler 300.

In various embodiments where at least a portion of a fire tube or fire tubes 106 is removed at step 204, the first end 106a and optionally the second end 106b of the fire tube or fire tubes 106 that had portions removed can be sealed such that the fluid from inside of the fluid cavity 112 is inhibited from entering the electrical enclosure 320. In certain embodiments where at least a portion of the first end plate 114 and/or second end plate 116 can be removed with the at least a portion of a first tube or fire tubes, the replacement plate 846c, 846d can be sealed to the elongate body 110 and/or remainder 814b of the fire end plate 114 or second end plate 116. The replacement plate 846c, 846d can also be sealed to the electrical heating apparatus 328. The seal can be formed by a weld, a braze, bolted gasketed flange, and/or a fitting. Sealing the replacement plate 846c, 846d to the elongate body 110 and/or remainder 814b of the fire end plate 114 or second end plate 116, and the electrical heating apparatus can inhibit fluid from egressing from the fluid cavity 112.

Referring again to FIG. 2, at step 208, electrical connections can be made or established between the electrical heating apparatuses 328 and the power distribution block 324b. Thus, energization of the electrical heating apparatuses 328 by the power distribution system 324a through the power distribution block 324b can be controlled by the hardware control device 322.

Optionally, at step 210, insulation (not shown) can be positioned intermediate the power distribution point 324b and the electrical heating apparatuses 328. The insulation can reduce heating of the power distribution block 324b that may be caused by the heating apparatus 328.

Referring to FIGS. 4A-4B, an electrical immersion heating apparatus 400 for a boiler is provided. As illustrated, the apparatus 400 comprises a first mounting flange 430, a second mounting flange 432, a heating element 434, support structures 436, and spacers 438. The apparatus 400 can comprise an electrical connection 442 configured to receive electrical power, such as from the power distribution block 324b, such that the heating element 434 can generate heat.

The first mounting flange 430 can be configured to mount in the first fire plate 114 in the boiler 100 of FIG. 3 and the second mounting flange 432 can be configured to mount in the second fire plate 116 in the boiler 100 of FIG. 3. For example, the first mounting flange 430 and/or second mounting flange 432 can comprise a shape suitable to be received by an opening from removing one of the fire tubes 106. In various examples, the opening from removing one of the fire tubes 106 is substantially circular and the respective mounting flange 430 and/or 432 is substantially circular such that the respective mounting flange 430 and/or 432 can fit within the opening. In certain examples, a portion of the one of the fire tubes 106 may be removed that is less than a whole of one of the first tubes 106 and the first mounting flange 430 and/or second mounting flange 432 may be sized to fit within the respective end 106a and/or 106b of the fire tube 106 that may be remaining after the portion is removed. For example, the first mounting flange 430 may friction fit within the first end 106a of one of fire tubes 106 and/or the second mounting flange may friction fit within the second end 106b of one of fire tubes 106. The first mounting flange 430 and/or the second mounting flange 432 can be welded and/or brazed to the first end plate 114, the second end plate 116, and/or a portion of the fire tubes 106.

The heating element 434 can extend from the first mounting flange 430 towards the second mounting flange 432. For example, the heating element 434 may not contact the second mounting flange 432 such that a gap 440 is defined intermediate the second mounting flange 432 and the heating element 434. The gap 440 can accommodate thermal expansion of the heating element 434 and/or the apparatus 400.

The first mounting flange 430 can comprise a bore and the heating element 434 can be received by the bore in the first mounting flange 430. The heating element 434 can form a fluid tight seal with the first mounting flange 430 by a weld, a braze, bolted gasketed flange, and/or a fitting. For example, the first mounting flange 430 may comprise a fitting as shown in FIG. 7B discussed herein below. In various examples, the apparatus 400 can comprise a single heat element 434 as shown in FIGS. 4A-4B, 6A-6B, and 7A-7C, at least two heating elements 536 as shown in FIGS. 5A-5C, or at least three heating elements (not shown).

The support structures 436 can extend from to the first mounting flange 430 to the second mounting flange 432 and the support structures 436 can be operatively coupled to the first mounting flange 430 and the second mounting flange 432. The support structures 436 can provide mechanical rigidity to the apparatus 400. As illustrated in FIGS. 4A-4B, the support structures 436 can comprise a rod extending from the first mounting flange 430 to the second mounting flange 432, a tube as shown in FIGS. 6A-6B and FIGS. 7A-7C, and/or a bar (not shown). In various examples, the apparatus 400 can comprise a single support structure 636 as shown in FIGS. 6A-6B, at least two support structures 436 as shown in FIGS. 4A-4B and 5A-5C, or at least three support structures 736 as shown in FIGS. 7A-7C.

The spacers 438 can extend from the support structure to the heating element 434. The spacers 438 can be operatively coupled to the heating element 434 and the support structures 436 such that the spacers 438 can physically support the position of the heating element 434 along a length, l, of the apparatus 400. In various examples, the apparatus 400 can comprise a single spacer 638 as shown in FIGS. 6A-6B, at least two spacers 438 as shown in FIGS. 4A-4B, 5A-5C, and 7A-7C, or at least three spacers (not shown).

Referring to FIGS. 5A-5C, an electrical immersion heating apparatus 500 for a boiler is provided. As illustrated, the apparatus 500 comprises a first mounting flange 530, a second mounting flange 532, two heating elements 534, support structures 536, spacers 538, a gap 540 defined intermediate the second mounting flange 532 and the heating elements 534, and an electrical connection 542. The electrical connection 542 can be connected to the power distribution block 324b to energize the heating element 534.

Referring to FIGS. 6A-6B, an electrical immersion heating apparatus 600 for a boiler is provided. As illustrated, the apparatus 600 comprises a first mounting flange 630, a second mounting flange 632, a heating element 634, a support structure 636, a spacer 638, a gap 640 defined intermediate the second mounting flange 632 and the heating elements 634, and an electrical connection 642. The electrical connection 642 can be connected to the power distribution block 324b to energize the heating element 634.

The support structure 636 can comprise a support tube extending from the first mounting flange 630 to the second mounting flange 632 and operatively coupled to the first mounting flange 630 and the second mounting flange 632. The heating element 634 can be disposed in a cavity 636a within the support structure 636. The support structure 636 can comprise an opening 636b to enable fluid in the fluid cavity 112 of the boiler 100 to enter the cavity 636a of the support structure 636 and contact the heating element 634. The support structure 636 can comprise an opening 636c to enable the fluid (e.g., steam, heated water) to exit the cavity 636a. When installed in the boiler 100, the opening 636b can be facing down and the opening 636c can be facing up.

In various examples, a tool can be used to split a tube to form the support structure 636. The first mounting flange 630 and/or the second mount flange 632 can be welded and/or brazed to the ends of the split tube to seal the tube and keep water from leaking out of the cavity 636a into the first electrical enclosure 320.

In various examples, the first mounting flange 630 can comprise a first diameter, d₁, the second mounting flange 632 can comprise a second diameter, d₂, and the support structure 636 can comprise a third diameter, d₃. The third diameter, d₃, can be less than the first diameter, d₁, and the second diameter, d₂, such that the apparatus 600 can be installed into the boiler 100 efficiently while mating to the first end plate 114 and the second end plate 116.

The apparatus 600 can comprise a cap 650 that can be mounted to the first end plate 114 of the boiler. The cap 650 can comprise a fourth diameter, d₄, that is larger than the first diameter, d₁, and an opening created in the first end plate 114 of the boiler by removing the fire tube. The cap 650 can be brazed and/or welded to the first end plate 114 and then attached to the first end 630 by fasteners 652, a weld (not shown), and/or a braze (not shown).

Referring to FIGS. 7A-7C, an electrical immersion heating apparatus 700 for a boiler is provided. As illustrated, the apparatus 700 comprises a first mounting flange 730, a second mounting flange 732, a heating element 734, a support structure 736, a spacer 738, a gap 740 defined intermediate the second mounting flange 732 and the heating elements 734, and an electrical connection 742. The electrical connection 742 can be connected to the power distribution block 324b to energize the heating element 734. The heating element 734 can be attached to the first mounting flange 730 with a fitting 740. The fitting 740 can seal to first flange 730 and optionally, the heating element 734. For example, the fitting 740 may be welded or brazed to a collar of the fitting 740 and the collar can compression fit to threads attached (e.g., welded, brazed, formed as part of) the first mounting flange 730. In various examples, the fitting 740 can compression fit the heating element 734 to the first mounting flange 730 by a sleeve (e.g., graphite sleeve) within the collar of the fitting 740. The apparatus 700 can be installed into the boiler 100 without the heating element 734 and the heating element 734 can be installed at a later time. The heating element 734 can also be replaced within the apparatus 700 enhancing the ability to maintain the operation of the boiler 100.

The apparatus 400, 500, 600, and/or 700 comprise a material suitable to withstand a high temperature (e.g., at least 90 degrees Celsius, at least 100 degrees Celsius, at least 110 degrees Celsius) and/or a corrosive environment, such as, for example, a metal, a metal alloy, a polymer, and/or graphite. For example, the apparatus 400, 500, 600, and/or 700 can comprise a metal, a metal alloy, and/or graphite.

With respect to the appended claims, those skilled in the art will appreciate that recited operations therein may generally be performed in any order. Also, although various operational flows are presented in a sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Although various examples have been described herein, many modifications, variations, substitutions, changes, and equivalents to those examples may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed examples. The following claims are intended to cover all such modification and variations.

As used herein, “intermediate” means that the referenced element is disposed between two elements but is not necessarily in contact with those elements. Accordingly, unless stated otherwise herein, an element that is “intermediate” a first element and a second element may or may not be adjacent to or in contact with the first and/or second elements, and other elements may be disposed between the intermediate element and the first and/or second elements.

Various features and characteristics are described in this specification to provide an understanding of the composition, structure, production, function, and/or operation of the invention, which includes the disclosed compositions, coatings, and methods. It is understood that the various features and characteristics of the invention described in this specification can be combined in any suitable manner, regardless of whether such features and characteristics are expressly described in combination in this specification. The Inventors and the Applicant expressly intend such combinations of features and characteristics to be included within the scope of the invention described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

Also, unless expressly specified or otherwise required by context, all numerical parameters described in this specification (such as those expressing values, ranges, amounts, percentages, and the like) may be read as if prefaced by the word “about,” even if the word “about” does not expressly appear before a number. Additionally, numerical parameters described in this specification should be construed in light of the number of reported significant digits, numerical precision, and by applying ordinary rounding techniques. It is also understood that numerical parameters described in this specification will necessarily possess the inherent variability characteristic of the underlying measurement techniques used to determine the numerical value of the parameters.

Notwithstanding that numerical ranges and parameters setting forth the broad scope of the invention are approximations, numerical values set forth in the specific examples are reported precisely as possible. Any numerical value, however, inherently contains certain errors necessarily resulting from the standard variation found in its respective testing measurements.

Reference throughout the specification to “various examples,” “some examples,” “one example,” “an example,” or the like means that a particular feature, structure, or characteristic described in connection with the example is included in an example. Thus, appearances of the phrases “in various examples,” “in some examples,” “in one example,” “in an example,” or the like in places throughout the specification are not necessarily all referring to the same example. Furthermore, the particular features, structures, or characteristics may be combined in any suitable manner in an example or examples. Thus, the particular features, structures, or characteristics illustrated or described in connection with one example may be combined, in whole or in part, with the features, structures, or characteristics of another example or other examples without limitation. Such modifications and variations are intended to be included within the scope of the present examples.

Whereas particular examples of this invention have been described above for purposes of illustration, it will be evident to those skilled in the art that numerous variations of the details of the present invention may be made without departing from the invention as defined in the appended claims.

While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

It is understood that the inventions described in this specification are not limited to the examples summarized in this Summary. Various other aspects are described and exemplified herein.

What is claimed is:

1. A method for converting a boiler from hydrocarbon powered to electrical powered, the method comprising:
converting a plurality of fire tubes of the boiler to electric heating apparatuses;
replacing a first end panel of the boiler, which is positioned over a first end plate of the boiler, which is operatively coupled to the plurality of the fire tubes, with an electrical enclosure configured for suppling 100 volts to 40,000 volts, the electrical enclosure comprising a hardware control device and a power distribution system; and
establishing electrical communication between the electrical heating apparatuses and the power distribution system.

2. The method of claim 1, wherein the hardware control device comprises a ground fault circuit interrupter, a current monitor circuit, a voltage monitor circuit, a water detection circuit, a fluid level control circuit, a low fluid control circuit, a pressure control circuit, a pump control circuit, a temperature limit control circuit, or a combination thereof.

3. The method of any of claims 1-2, wherein converting a plurality of the fire tubes of the boiler to electric heating apparatuses comprises introducing a heat transfer medium and an electrical heating element into the plurality of the fire tubes.

4. The method of claim 3, wherein the heat transfer medium comprises magnesium oxide, oil, aluminum oxide, heat transfer fluid, or a combination thereof.

5. The method of claim 1, wherein converting the plurality of fire tubes of the boiler to electric heating apparatuses comprises removing at least a portion of a first fire tube of the plurality of fire tubes and introducing an electrical immersion heating apparatus in place of the at least portion of the first fire tube.

6. The method of claim 5, further comprising sealing at least a first end of the first fire tube such that a liquid is inhibited from entering the electrical enclosure from the first fire tube.

7. The method of claim 6, wherein the seal is formed by a weld, a braze, bolted gasketed flange, and/or a fitting.

8. The method of any of claims 5-7, wherein the electrical immersion heating apparatus comprises:
a first mounting flange configured to mount in a first fire plate in the boiler;
a second mounting flange configured to mount in a second fire plate in the boiler;
a heating element extending from the first mounting flange towards the second mounting flange, wherein a gap is defined between the heating element and the second mounting flange; and
a support structure extending from the first mounting flange to the second mounting flange.

9. The method of claim 8, wherein the apparatus further comprises a spacer extending from the support structure to the heating element.

10. The method of any of claims 8-9, wherein the heating element is attached to the first mounting flange with a fitting.

11. The method of any of claims 8-10, wherein the support structure comprises a rod extending from the first mounting flange to the second mounting flange.

12. The method of any of claims 8-11, wherein the support structure comprises at least two rods extending from the first mounting flange to the second mounting flange.

13. The method of any of claims 8-12, wherein the apparatus comprises at least two heating elements.

14. The method of any of claims 8-13, wherein the support structure comprises a support tube extending from the first mounting flange to the second mounting flange, the heating element is disposed in a cavity defined within the support tube, and at least one opening is defined in the support tube to enable fluid to contact the heating element.

15. The method of claim 14, wherein the first mounting flange comprises a first diameter, the second mounting flange comprises a second diameter, and the support tube comprises a third diameter, wherein the third diameter is less than the first diameter and the second diameter.

16. The method of any of claims 9-15, wherein the apparatus comprises at least two spacers extending from the support structure to the heating element.

17. The method of any of claims 1-16, wherein the electrical enclosure comprises a vent.

18. The method of any of claims 1-17, further comprising positioning insulation between the hardware control device and the electrical heating elements.

19. The method of any of claims 1-18, wherein an elongate body of the boiler is not modified.

20. An electrical immersion heating apparatus for a boiler, the apparatus comprising:
a first mounting flange configured to mount in a first fire plate in the boiler;
a second mounting flange configured to mount in a second fire plate in the boiler;
a heating element extending from the first mounting flange towards the second mounting flange, wherein a gap is defined between the heating element and the second mounting flange; and
a support structure extending from the first mounting flange to the second mounting flange.

21. The apparatus of claim 20, further comprising a spacer extending from the support structure to the heating element.

22. The apparatus of any of claims 20-21, wherein the heating element is attached to the first mounting flange with a fitting.

23. The apparatus of any of claims 20-22, wherein the support structure comprises a rod extending from the first mounting flange to the second mounting flange.

24. The apparatus of any of claims 20-23, wherein the support structure comprises at least two rods extending from the first mounting flange to the second mounting flange.

25. The apparatus of any of claims 20-24, wherein the apparatus comprises at least two heating elements.

26. The apparatus of any of claims 20-25, wherein the support structure comprises a support tube extending from the first mounting flange to the second mounting flange, the heating element is disposed in a cavity defined within the support tube, and at least one opening is defined in the support tube to enable fluid to contact the heating element.

27. The apparatus of claim 26, wherein the opening the support tube is formed by splitting the support tube with a tool.

28. The apparatus of any of claims 26-27, wherein the first mounting flange comprises a first diameter, the second mounting flange comprises a second diameter, and the support tube comprises a third diameter, wherein the third diameter is less than the first diameter and the second diameter.

29. The apparatus of any of claims 20-28, wherein the apparatus comprises at least two spacers extending from the support structure to the heating element.

30. A boiler comprising the apparatus of any of claims 20-29.

31. A method for converting a boiler from hydrocarbon powered to electrical powered utilizing the apparatus of any of claims 20-30.
